(19) United States
(12) Patent Application Publication
(10) Pub. No.: US 2007/0276618 A1
(43) Pub. Date: Nov. 29, 2007

(54) Method for Supporting Dietary Habits, a System and a Computer Program Therefor

(76) Inventor: Zbigniew Mlynarski, Warsaw (PL)

Correspondence Address: WELSH & KATZ, LTD, 120 S RIVERSIDE PLAZA, 22ND FLOOR, CHICAGO, IL, 60606, US

(21) Appl. No.: 10/594,108

(22) PCT Filed: Mar. 25, 2005
(86) PCT No.: PCT/PL05/00021

§ 371 Date: Jul. 9, 2007

(30) Foreign Application Priority Data
Mar. 25, 2004 (PL) P.366597

(51) Int. Cl. G06F 19/00

(52) U.S. Cl. 702/82

(57) ABSTRACT

The object of the invention is a method for supporting dietary habits and a system and a computer program therefore. The invention enables to develop the healthy and reasonable nutrition habits within minimum limitations and inconveniences which are related to the change of the diet.

### CROSS REFERENCES TO RELATED APPLICATION

This application is a national phase application based upon priority International PCT Patent Application No. PCT/PL2005/000021 filed Mar. 25, 2005, International Publication No. WO 2005/093633 A2 published Oct. 6, 2005, which is based upon priority Poland Application No. P366597, filed Mar. 25, 2004.

### BACKGROUND OF THE INVENTION

1. The Technical Field

The invention relates to a method for supporting dietary habits, a system and a computer program therefore. The invention enables to develop healthy and reasonable nutrition habits within minimum limitations and inconveniences which are related to a change of a diet. Applying the invention makes it possible to stimulate and fulfill the requirements of a sound nutrition by consuming favorite products and dishes of the user.

2. State of the Art

The numerous documents describing methods, devices and programs allowing to use different diets, wholesome nutrition programs and slimming are known in the prior the art.

Document JP 2002083052 describes a nutrition guidance system. The method depends on the fact that the user makes a choice of favorite food from a wide range of food elements and the daily amount of the consumed food, and further the data is introduced on the nutrition card including the chosen meals, quantity of dishes, the personal data such as age and sex, body structure and life activity, etc. The automatic data reader connected to the data converter reads the data from the card, and then the converter analyzes the details concerning the meals and compares them with the nutrition requirements determined on the basis of the personal data and makes out the instructions concerning the optimal nutrition.

Document JP 2001101157 discloses a device and system for diet management and a recording medium. According to the invention, the means for recording data records the identifier determining the type of meal such as a dish from a menu in worker canteen and information concerning the specific user. Then, the disclosed device makes the choice of information concerning the given food from the database of nutritive value of the food components. Then it makes the choice of information concerning the specific user, after which it makes a choice of information concerning the daily requirements for the specific user for the nutrition components from the essential nutrition components database and then the device makes a choice of specific nutrition instructions for the given user on the basis of the chosen data.

Document U.S. Pat. No. 4,951,197 presents a more general approach and discloses a system for managing the use of a computer analysis of the hitherto medical “history”, diet habits, dimensions of the body, intensity of doing exercises and taste preferences of a user in order to provide menu which contains the specific quantity of calories to keeps the reasonable weight.

However, despite of numerous tests and different directions of research no method has been worked out that would allow to develop the habits of healthy nutrition and rational nourishment by the user within minimum limitations and inconveniences which are related to the change of the diet. Many tests have presented the approach which was to assume the user's preferences, to meals consumed more willingly and more frequently than the other but the system of supporting or development of diet habits which would make it possible, in a clear, direct and organized way, to consider the nutrition preferences to the user is not known in the prior art, nor the recommendations concerning the later diet are.

### SUMMARY OF THE INVENTION

Surprisingly it has been found the development of a method and a system and program for realization therefore can make use of a specification of favorite nutrition products presented, for example, in form of a chart and/or electronic database. Content of such a specification, i.e. specific nutrition products together with given amount, introduced during the realization of the method, is an essential element of the system and enables to the make analysis, according to the defined algorithm, of the information concerning the nutrition products consumed on the given day by the specific user and makes it possible to generate the list of products recommended for consumption by taking the products from the list of the favorite products according to the established criteria.

The object of the invention is a method for supporting dietary habits, which is characterized as follows:
a) a specification of nutrition products together with the given content of the chosen food components for each of the nutrition products is created;
b) a recommended consumption of chosen food components is established by the user in the established period of time;
c) a specific list of nutrition products is created;
d) information concerning the nutrition products consumed by the user is introduced;
e) a content of the chosen food components in the consumed nutrition products is established on the basis of the data from previously prepared specifications (point a) to d));
f) a quantity of food components in consumed nutrition products supplied to the human body is compared to the recommended consumption of each of the food components in the given period of time and the remaining requirements for the chosen food components are fixed for the exact time in accordance to the quantity of the appropriate food components deducted from the established requirement of the chosen food components;
g) a list of recommended nutrition products is presented, said list taking into consideration the specific list of nutrition products and the remaining requirements of the chosen food components.

According to the preferred embodiment of the invention a specific list of nutrition products is created by introducing the information concerning the kind and quantity of a nutrition product.

Furthermore, according to the preferred embodiment of the invention, information concerning the kind and quantity of the nutrition product is introduced by the user.

According to the preferred embodiment of the invention the specific list of the nutrition products is introduced by the user.

According to one of the preferred embodiment of the invention, a specific list of nutrition products is created by introducing a set of dishes offered in a restaurant or a canteen.

According to another preferred embodiment of the invention, the set of dishes offered in a restaurant or a canteen is introduced by means of computer network.

According to still another preferred embodiment of the invention, the information concerning the nutrition products consumed by the user is introduced by the user.

According to still another preferred embodiment of the invention, a list of recommended nutrition products is presented in an ordered way depending on the degree in which it is possible to meet the remaining requirements for the food components. The list of recommended nutrition products is presented taking into consideration the history of consumption during a fixed period of time.

According to another preferred embodiment of the invention, a list of recommended nutrition products is presented taking into consideration the information concerning the glycemic index (01) of particular nutrition products.

Further more, the object of the invention is a system for supporting dietary habits, characterized in that contains the following:
a storage element for storing information concerning contents of the specific food components in nutrition products, information about the consumption of the chosen food components in a fixed period of time recommended for the user, information about the specific nutrition products, information about the consumed nutrition products and information concerning the user and the consumption of the chosen food components in a given period of time recommended for the user;
a loading element for introducing the data concerning the kind and quantity of the consumed nutrition products and the data concerning the user and the consumption of the chosen food components in a given period of time recommended for the user;
an analytical element for calculating and establishing the remaining requirements for the chosen food components for a fixed period of time after taking into consideration the consumed nutrition products;
a presentation element for displaying the list of recommended nutrition products.

According to the preferred embodiment of the invention, the storage element is organized in the form of an electronic database.

According to another preferred embodiment of the invention, the loading element has a form of a keyboard.

According to still another preferred embodiment of the invention the presentation element has a form of a display.

According to the next preferred embodiment of the invention, the system has q form of a portable device containing a display and buttons.

The object of the invention is also a computer program for supporting dietary habits, characteristic for the fact that it consists of the following programming code modules recorded on a data carrier readable by means of a computer:
a storage module for storing information concerning the contents of the specific food components in nutrition products, information about consumption of chosen food components in the established period of time recommended for the user, information about specific nutrition products, information about the consumed nutrition products and information concerning the user and consumption of the chosen food components in a given period of time recommended for the user;
a loading module for interdicting the data concerning the kind and quantity of the consumed nutrition products and data concerning the user and the consumption of the chosen food components in the established period of time recommended for the user;
an analytical module for calculating and establishing the remaining requirements of the chosen food components for the specific period of time after taking into consideration the consumed nutrition products;
a presentation module for displaying the list of recommended nutrition products.

According to the preferred embodiment of the invention of the computer program for supporting dietary habits serves to implement the method according to the invention.

The definition “food components” used within the present application denotes the nutritional components (e.g. proteins, carbohydrates, sodium, vitamin C) as well as the substances being consumed, said substances not being nutritional components because they supply no assimilable chemical compounds nor energy (e.g. cellulose) to the human organism.

The definition “nutrition product” used within this application denotes the products ready for consumption (e.g. tomatoes, fruit juices), raw food or semi-finished food products for preparing meals (e.g. veal, oil, butter) and dishes (e.g. scrambled eggs, roast lamb, apple cake). According to such a definition, every nutrition product contains particular food components.

The definition “recommended consumption” used within this application denotes a recommended range of the amount of given food components in a fixed period of time taking into consideration the requirements as well as the capabilities of a human organism. The range is determined by the lower limit or upper limit or by both limits simultaneously, depending on the specific food component.

The definitions “food” and “nutrition” used interchangeably within this application denote all compounds taken in by a human organism enterally (orally), i.e. food components, medicines, water.

A more detailed description of the invention is provided in the following description and appended claims taken in conjunction with the accompanying drawing.

### BRIEF DESCRIPTION OF THE DRAWINGS

The invention is illustrated by means of the following example and the drawing enclosed, in which:

FIG. 1 shows a list of nutrition products and a form for introducing or modifying the data concerning the composition and the contents of food components in the chosen product.

FIGS. 2(A-F) shows the form for introducing or modifying the user's data.

FIG. 3 shows the specification (the list) of specific nutrition products and the form for introducing or modifying the data concerning the composition and the contents of the food components in a chosen product.

FIG. 4 shows the prepared menu together with the analysis of the consumed nutrition products from the point of view of the fulfillment of the recommended consumption of the chosen food components.

### DETAILED DESCRIPTION OF THE INVENTION

The following is a detailed description and explanation of the preferred embodiments and best modes for embodying the invention along with some examples thereof.

The example presented below serves for a more detailed illustration of the invention however it does not limit the scope of the invention in any way.

### EXAMPLE 1

The Usage of the Program According to the Invention for Implementation of the Method According to the Invention.

The preparation of the program in the primary phase for the use of the user includes the following stages:
1) The data concerning the nutrition products is introduced to the electronic database to the part of the module for storing information. The data includes:
   a name of a given nutrition product in case of a meal or optionally a name of the components of a dish.
   the contents of the chosen food components per 100 g of the given nutrition product.
   the glycemic index value for 100 g of the given nutrition product.
   the quantity of energy supplied to the human organism by consuming 100 g of the given nutrition product.

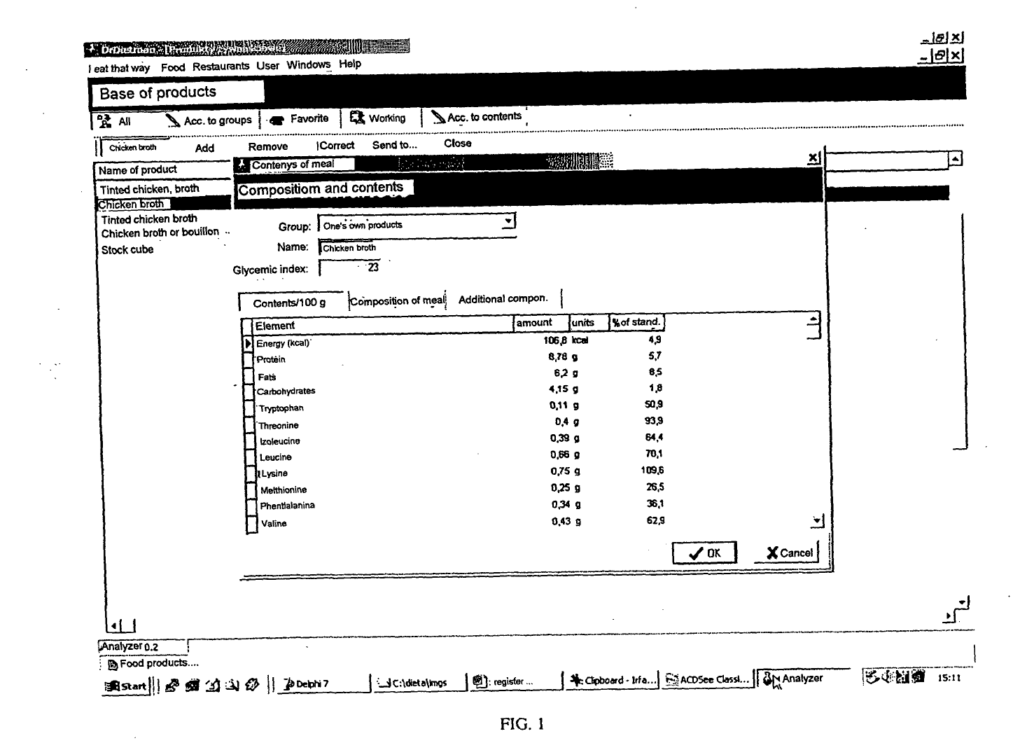

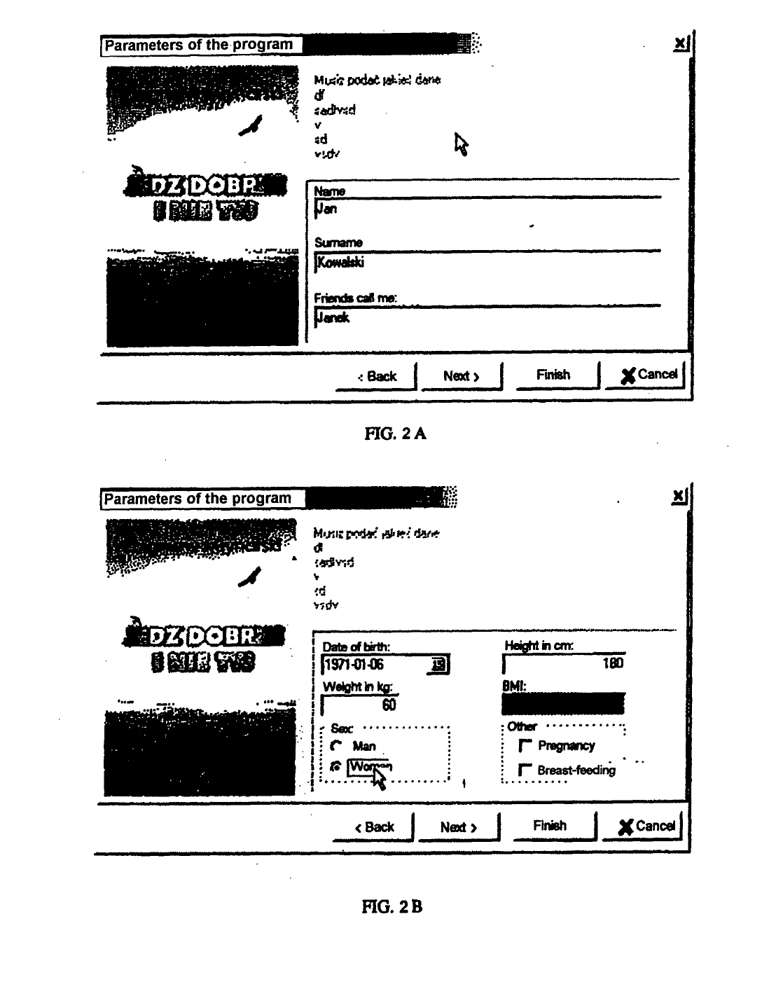

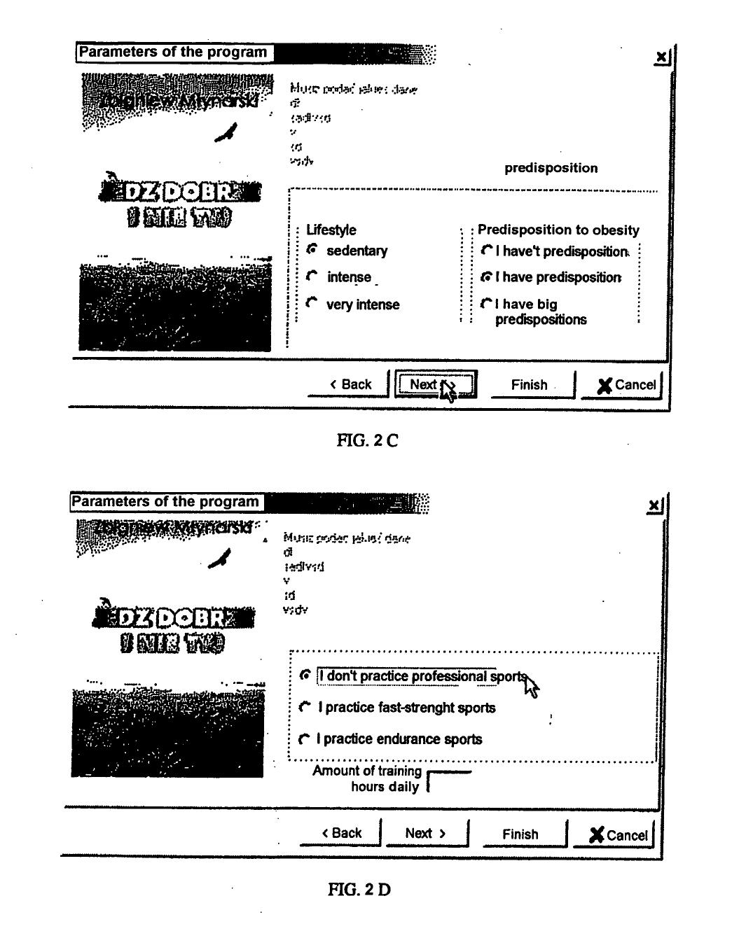

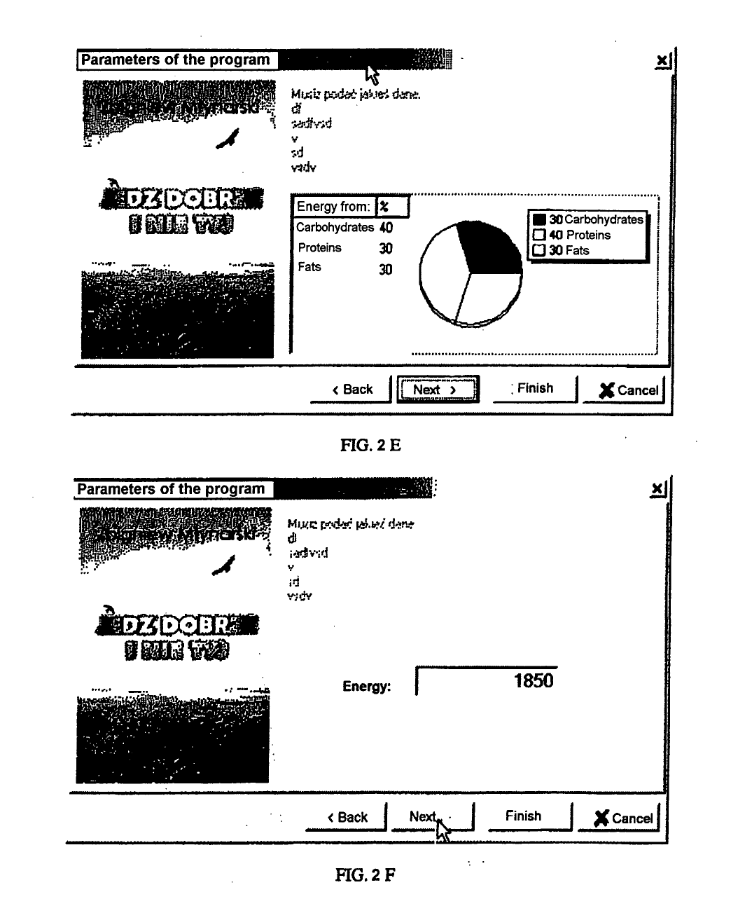

The form for introducing or modifying the data concerning the composition and the contents of food components in the chosen product is shown in FIG. 1.
2) The data concerning the daily recommended consumption of chosen food components, are introduced to the next electronic database which makes the part of the module for storing information taking into consideration the user's individual features such as state of health of the user, his/her body weight, age, sex, height, lifestyle and predisposition to obesity. The lifestyle and tendency to be overweight is taken into consideration in such a way that the average data concerning the recommended consumption is introduced in the form of three possible variants of lifestyle (for women) and four (for men) (a sitting variant, an intense variant, a medium-level intense variant (in the case of men), and a very intense variant) and as for the inclination to obesity (not obesity-prone/a little obesity-prone/seriously obesity-prone). Additionally, in case of recommended consumption of chosen food components for women, the variants for pregnancy and breast-feeding are taken into consideration. The form for introducing or modifying the data concerning the users is shown in FIGS. 1(A-F).

The next phase is connected with the first period of utilization of the program by the user. During this period the user introduces his/her own settings and individualizes the program. At this phase the user introduces (using the module for introduction and by using an external device e.g. a keyboard or buttons of a portable device) the data concerning his/her weight of body, height, age, sex and makes a choice of one from the accessible variants of lifestyle and inclination to obesity, and—in case of women—if needed, marks the variant for a pregnancy or breast-feeding. The program makes a choice of a suitable variant of the recommended consumption standards depending on the introduced data concerning the user. The standard recommended consumption of the specific food components can be modified manually, e.g. according to with particular recommendations of a doctor.

During the first days or weeks, the user makes a list of the specific nutrition products in the module for storing information. The list is organized in the form of an electronic database. The user makes the list by introducing (also by the module for introducing and by an external device, e.g. a keyboard or buttons of a portable device) the information concerning the nutrition products consumed by the user. The information contains:
the name of a given nutrition product in case of a meal or optionally the names of the components of a dish,
the quantity of the consumed portion—is given in grams or in manually introduced units typical for the given nutrition product, e.g. milliliters, pieces.

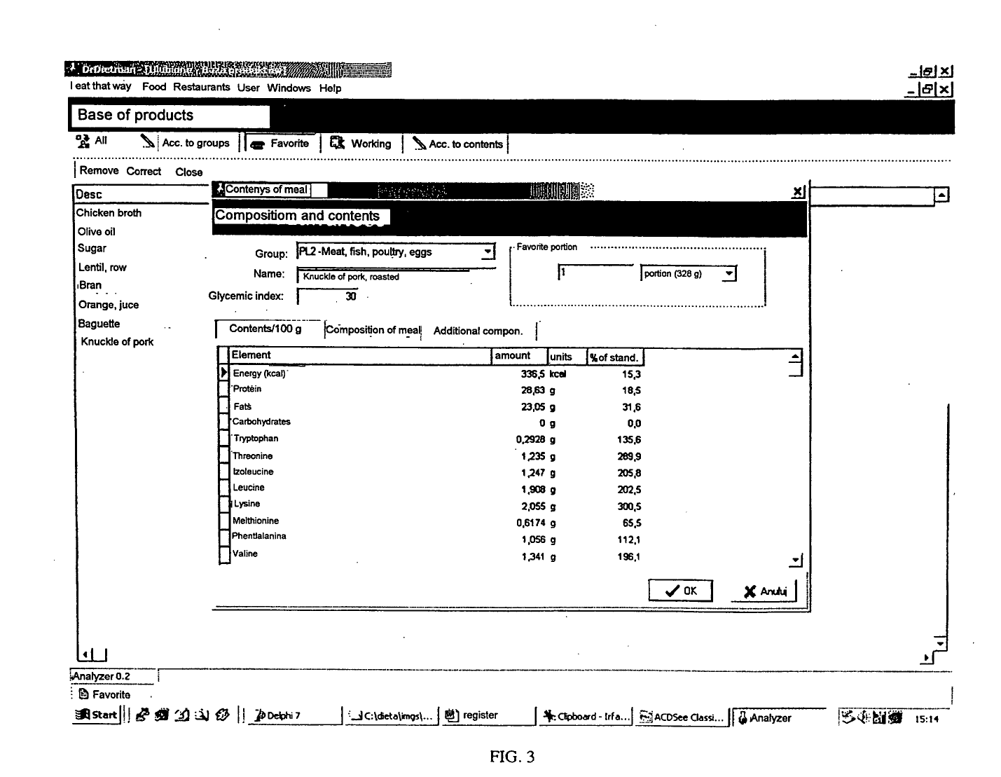

The specification (the list) of the specific nutrition products and a form for introducing or modifying the data concerning the composition and the contents of the food components in the chosen specific product are shown in FIG. 3.

In one of the embodiments of the invention, the user can take in obtain the whole menu from an electronic base provided by a selected restaurant and/or canteen by means of a computer network and include it entirely or partly into the list of the nutrition products of the system, whereby said menu contains the data indicate above.

The next phase is the use of the program previously adapted to the personal needs and demands for supporting dietary habits, i.e. of developing the habits allowing a healthy and reasonable nutrition in the way as gentle and comfortable as possible. In this phase the user after consuming the meal introduces (by means of the module for introducing and by an external device, e.g. a keyboard) the information concerning the meal. The information contains:
a name of the given nutrition product in case of a meal or optionally the names of the components of a meal,
a size of the consumed portion—in grams or in manually introduced units typical for the given nutrition product, e.g. milliliters, pieces.

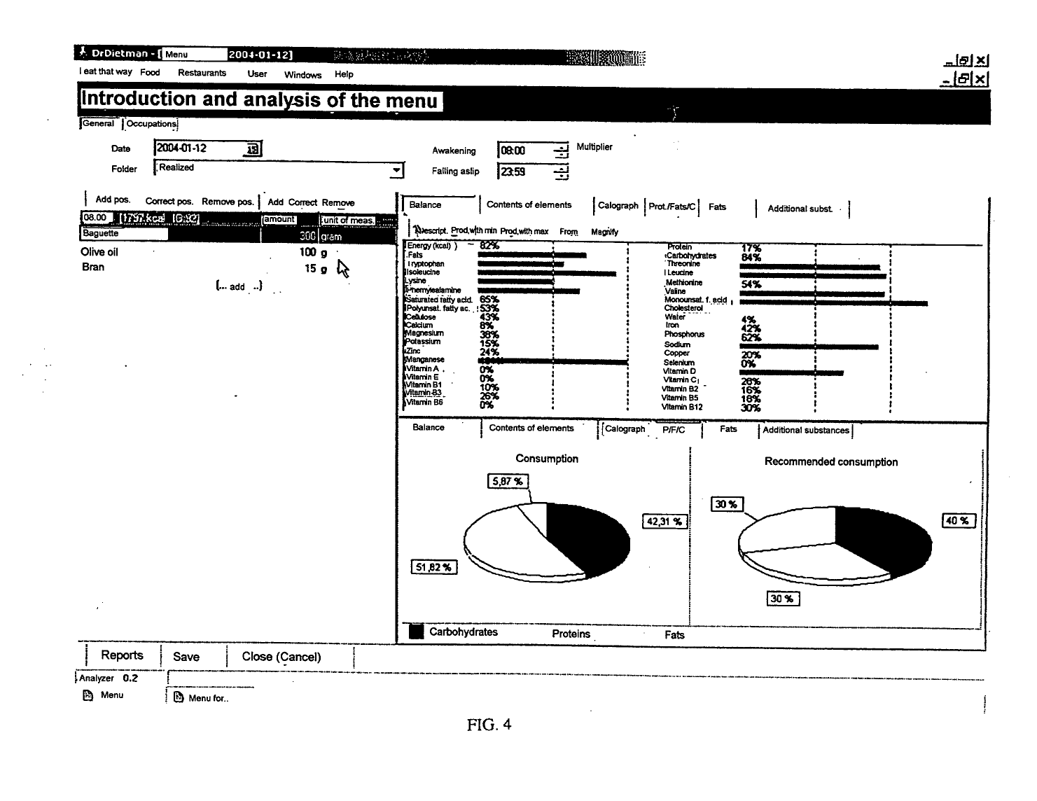

The prepared menu together with the analysis of the consumed nutrition products from the point of view of the fulfillment of the recommended consumption of the chosen food components is shown in FIG. 4.

The introduced data is processed in the analytical module, said processing comprises the comparison of the quantity of food components consumed on a given day taking into consideration its consumption on the previous days and is compared to the recommendation concerning their consumption and nutrition products from the specific list of nutrition products or from the list of meals served in canteens or restaurants (which are included in the general list of the nutrition products of the system) which should be consumed in order to supply the user's organism with the food so that it should be similar to the recommended supply. The nearer the consumption of the given nutrition product to the recommended consumption of the food components is, the closer to the beginning of the list will it be presented. The mentioned list of recommended nutrition products which are recommended to the user for consuming as consecutive meals during the day is presented by a presentation unit, e.g. a display.

Although embodiments and examples of the invention have been shown and described, it is to be understood that various modifications, substitutions, and/or rearrangements of the software program, process (method) steps, parts, components, equipment, apparatus and/or devices, as well as other software steps and methods can be made by those skilled in the art without departing from the novel spirit and scope of the invention.

What is claimed is:

1. A method for supporting dietary habits, characterized in that:
a) a specification of nutrition products together with the given content of the chosen food components for each of the nutrition products is created;
b) a recommended consumption of the chosen food components is established by the user in the established period of time;
c) a specific list of nutrition products is created;
d) the information concerning the nutrition products consumed by the user is introduced;
e) the content of the chosen food components in the consumed nutrition products is established on the basis of the data from previously prepared specifications (point a) to d));
f) the quantity of food components in the consumed nutrition products supplied to the human organism is compared to the recommended consumption of each of the food components in the given period of time and the remaining requirements for the chosen food components are fixed for the exact time in accordance to the quantity of the appropriate food components deducted from the established requirement of the chosen food components;
h) a list of the recommended nutrition products is presented taking into consideration the specific list of nutrition products and the remaining requirements of the chosen food components.

2. The method according to the claim 1, characterized in that a specific list of nutrition products is created by introducing the information concerning the kind and quantity of the nutrition product.

3. The method according to the claim 1, characterized in that the information concerning the kind and quantity of the nutrition product is introduced by the user.

4. The method according to the claim 1, characterized in that a specific list of nutrition products is created by introducing a set of dishes offered in a restaurant or a canteen.

5. The method according to the claim 1, characterized in that the set of offered dishes in restaurants or canteens is introduced by means of a computer network.

6. The method according to the claim 1, characterized in that the information concerning the nutrition products consumed by the user is introduced by the user.

7. The method according to the claim 1, characterized in that the list of the recommended nutrition products is presented in an ordered way depending on the degree in which they enable to complete the remaining requirements of the food components.

8. The method according to the claim 7, characterized in that the list of the recommended nutrition products is presented taking into consideration the history of consumption during a fixed period of time.

9. The method according to the claim 1 characterized in that the list of the recommended nutrition products is presented taking into consideration information concerning the glycemic index (GT) of the particular nutrition products.

10. The system for supporting dietary habits, characterized in that it contains:
a storage element for storing the information concerning the content of the specific food components in the nutrition products, information about the consumption of the chosen food components in a fixed period of time recommended for the user, information about the specific nutrition products, information about the consumed nutrition products and information concerning the user and the consumption of the chosen food components in a given period of time recommended for the user;
a loading element for introducing the data concerning the kind and quantity of the consumed nutrition products and the data concerning the user and the consumption of the chosen food components in a given period of time recommended for the user;
an analytical element for calculating and establishing the remaining requirements for the chosen food components on a fixed period of time after taking into consideration the consumed nutrition products;
a presentation element for displaying the list of the recommended nutrition products.

11. The system according to claim 10, characterized in that the storage element is organized in the form of an electronic database.

12. The system according to claim 10, characterized in that the loading element has the form of a keyboard.

13. The system according to claim 10 characterized in that the presentation element has the form of a display.

14. The system according to claim 10, characterized in that the system has the form of a portable device containing a display and buttons.

15. The computer program for supporting dietary habits, comprising the following programming code modules recorded on a data carrier readable by a computer:
a storage module for storing information concerning the contents of the specific food components in nutrition products, information about consumption of chosen food components in an established period of time recommended for the user, the information about specific nutrition products, information about the consumed nutrition products and information concerning the user and consumption of the chosen food components in a given period of time recommended for the user;
a loading module for introducing the data concerning the kind and quantity of the consumed nutrition products and data concerning the user and the consumption of the chosen food components in the established period of time recommended for the user;
an analytical module for calculating and establishing the remaining requirements for the chosen food components for the specific period of time after taking into consideration the consumed nutrition products;
a presentation module for displaying the list of the recommended nutrition products.

16. The computer program for supporting dietary habits, characterized in that it serves to implement the method according to claim 1.

17. The method according to the claim 7 characterized in that the list of the recommended nutrition products is presented taking into consideration information concerning the glycemic index (GT) of the particular nutrition products.

18. The method according to the claim 8 characterized in that the list of the recommended nutrition products is presented taking into consideration information concerning the glycemic index (GT) of the particular nutrition products.
